(19) United States
(12) Patent Application Publication
(10) Pub. No.: US 2008/0096481 A1
(43) Pub. Date: Apr. 24, 2008

(54) Ventilating Device for Motor Vehicles

(76) Inventor: Alessandro Spaggiari, Correggio (Reggio Emilia) (IT)

Correspondence Address: NATH & ASSOCIATES, 112 South West Street, Alexandria, VA, 22314, US

(21) Appl. No.: 10/574,502

(22) PCT Filed: Jul. 8, 2005
(86) PCT No.: PCT/IB05/02216

§ 371 Date: Apr. 3, 2006

(30) Foreign Application Priority Data
Jul. 13, 2004 (IT) BO2004A000436

(51) Int. Cl. B60H 1/26

(52) U.S. Cl. 454/137

(57) ABSTRACT

Described is a motor vehicle ventilating device equipped with a housing (3), fastening elements (4) for attaching the housing (3) to the roof of the cabin of a motor vehicle (2) and a fan (5) positioned in the housing (3); the housing (3) defines a closed chamber (9) equipped with an air inlet opening (10) and at least one air outlet opening (11) for delivering to the vehicle cabin through the outlet opening (11) the air that is drawn into the housing (3) by the fan (5) through the inlet opening (10); the housing (3) is defined by two half-shells (12, 13) joined to each other in airtight manner, the first half-shell (12) being designed to be attached to the cabin roof and being equipped with a seat (18) for mounting the motor (6) of the fan (5) impeller (7), and the second half-shell (13) having the air inlet and outlet openings (10, 11) made in it; in an alternative embodiment, the motor (6) of the fan (5) impeller (7) is made in the second half-shell (13); the fan is of the axial-flow type and the air outlet opening or openings (11) are positioned at the sides of the impeller (7) in respective radial directions of the impeller (7) itself.

### TECHNICAL FIELD

This invention relates to a ventilating device for motor vehicles, suitable in particular for installation in automobiles and the like, that is to say, in vehicles with cabins of relatively limited height.

### BACKGROUND ART

Automotive climate control systems have undergone considerable technological development in recent years.

In this specification, the term “climate control system” is used to mean any system comprising an air heating device and an air cooling device and which may include a unit for controlling and adjusting the two devices in such a way as to create optimum temperature conditions in the vehicle cabin.

Early climate control systems, although effective in terms of air cooling or heating capacity, were not entirely satisfactory because the heated or cooled air was not uniformly circulated within the vehicle cabin. In particular, the ventilation outlets were located only on or near the dashboard which usually meant that the heated or cooled air coming out of them could not always effectively reach the back of the cabin.

To improve air circulation, auxiliary ventilation outlets were provided at the back of the cabin at floor level but without obtaining satisfactory results.

Ventilating devices designed to be fitted to the cabin roof were also proposed.

A vehicle cabin ventilator of this type is described, for example, in U.S. Pat. No. 3,486,436.

This ventilator comprises a housing designed to be fitted to the cabin roof, near the windscreen, and containing a centrifugal fan equipped with a suitable filter. The housing has a plurality of outlets, arranged in line, for delivering to the vehicle cabin the air that is drawn into the housing by the centrifugal fan.

A ventilating device of the type described in U.S. Pat. No. 3,486,436 has a complex structure, however, and involves relatively labour-intensive procedures not only to assemble its components but also to install it in the vehicle cabin roof.

Further, ventilating devices of the type described in U.S. Pat. No. 3,486,436, although capable of effectively circulating the air inside the vehicle, are suitable for installation in large cabins such as those of trucks and the like but, on account of their bulky structure, particularly in the vertical direction, cannot be installed in automobiles, which have relatively small cabins. Moreover, the large size of the devices also means that they can be installed only near the windscreen, which in turn means that the back of the cabin remains poorly ventilated.

### DISCLOSURE OF THE INVENTION

One aim of the present invention is to provide a motor vehicle ventilating device with an easy-to-assemble structure permitting low production costs and quick, easy installation in the motor vehicle cabin.

Another aim of the invention is to provide a motor vehicle ventilating device which, on the one hand, guarantees effective air distribution inside the vehicle while at the same time having a simple, compact structure allowing it to be installed in small vehicles such as automobiles and the like.

Yet another aim of the invention is to provide a motor vehicle ventilating device that is compact especially in the vertical direction so that it can be installed anywhere along the top of the cabin, even in automobiles and the like.

In accordance with the aims listed above, the invention provides a motor vehicle ventilating device as defined in claim 1.

The claims dependent on claim 1 refer to preferred, advantageous embodiments of the invention.

### DESCRIPTION OF THE DRAWINGS

The advantages of the invention will become more apparent from the detailed description which follows, with reference to the accompanying drawings which illustrate a preferred, non-restricting embodiment of the invention and in which:

FIG. 1 is a plan view of a preferred embodiment of the motor vehicle ventilating device according to the invention;

FIG. 2 is a side view of the device of FIG. 1;

FIG. 3 is a cross-section through line III-III in FIG. 1;

FIG. 4 is a perspective view of the device of FIG. 1;

FIG. 5 is a perspective view of a component of the device of FIG. 1;

FIG. 6 is another perspective view of the device of FIG. 1;

FIG. 7a schematically illustrates the device of FIG. 1 installed in an automobile cabin;

FIGS. 7a and 7b schematically illustrate two variants of the device of FIG. 1 in respective installation configurations in an automobile cabin;

FIGS. 8 and 9 show details of a first variant of the device according to the invention;

FIGS. 10 to 13 illustrate a second and a third variant of the device of FIG. 1.

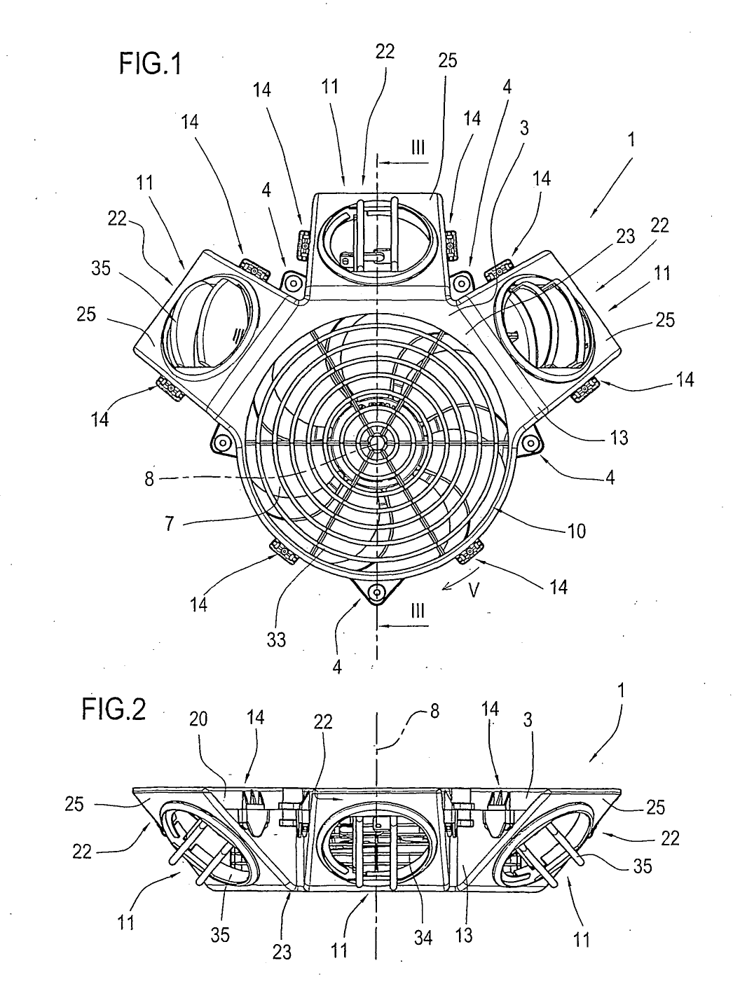

### DETAILED DESCRIPTION OF THE PREFERRED EMBODIMENTS OF THE INVENTION

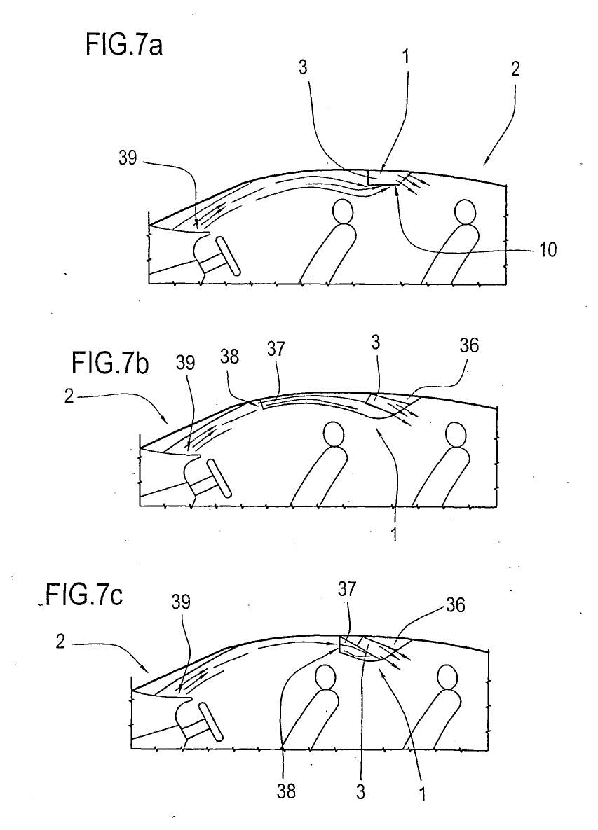

With reference to the accompanying drawings, the numeral 1 denotes a motor vehicle ventilating device whose compact size makes it particularly suitable for installation in automobiles 2 and the like (FIGS. 7a-7c), that is to say, in vehicles having relatively small cabins.

The device 1 comprises a housing 3, or outer shell, having a plurality of annular fastening protrusions 4 enabling it to be easily attached to the roof of a vehicle 2 cabin (FIG. 7a). More specifically, the protrusions 4 are designed to be attached to the cabin roof by means of screws or similar fastening elements which are not illustrated.

The housing 3 contains an axial fan 5 comprising a motor 6 and an impeller 7 rotationally driven by the motor 6 about a central axis 8.

The housing 3 defines a closed chamber 9 equipped with a circular air inlet opening 10 and, in the embodiment illustrated, three circular air outlet openings 11 for delivering to the vehicle cabin through the outlet opening or openings (11) the air that is drawn into the housing (3) by the fan (5) through the inlet opening (10).

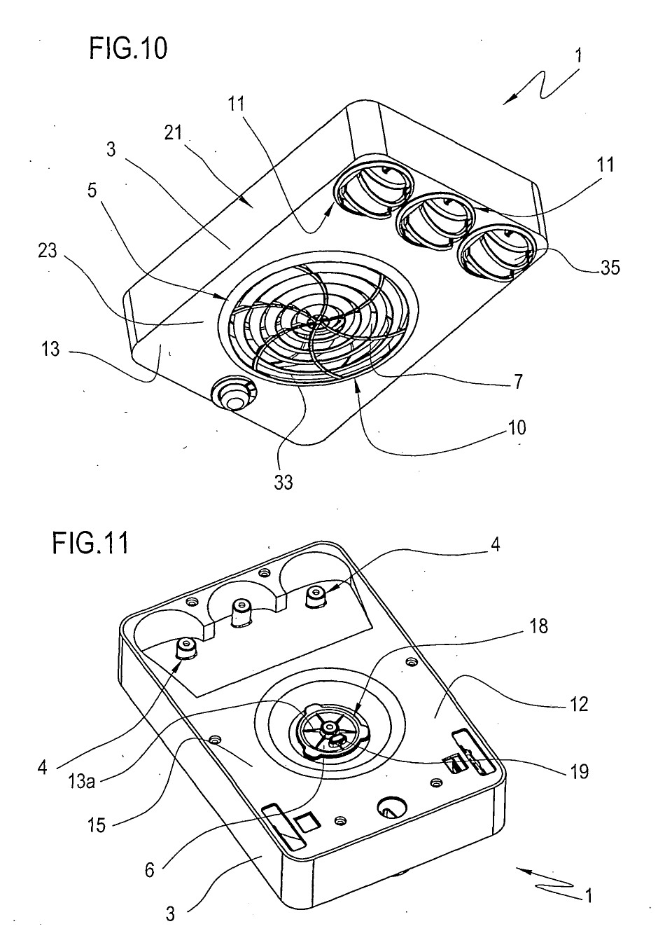

The fan 5 creates an air flow and a high pressure zone downstream of it against the sides of the housing 3 of the device 1. The air escapes from the high pressure zone through the outlet openings 11. The latter are, preferably, positioned at the sides of the impeller 7 in respective radial directions of the impeller 7 itself. Alternatively, as in the embodiments illustrated in FIGS. 10, 11 and 12, 13, the outlet openings 11 are positioned at the side of the impeller 7 in skew directions, that is to say, at an angle to the impeller 7, or in the same plane as the impeller 7 and in directions parallel to but offset from the impeller itself.

In other embodiments that are not illustrated, the inlet opening 10 may be substituted by two or more inlet openings that are equivalent in terms of total air passage area.

Similarly, the three outlet openings 11 may be substituted by one or more outlet openings that are equivalent in terms of total air passage area. Further, both the inlet opening 10 and the outlet openings 11 may be other than circular in shape.

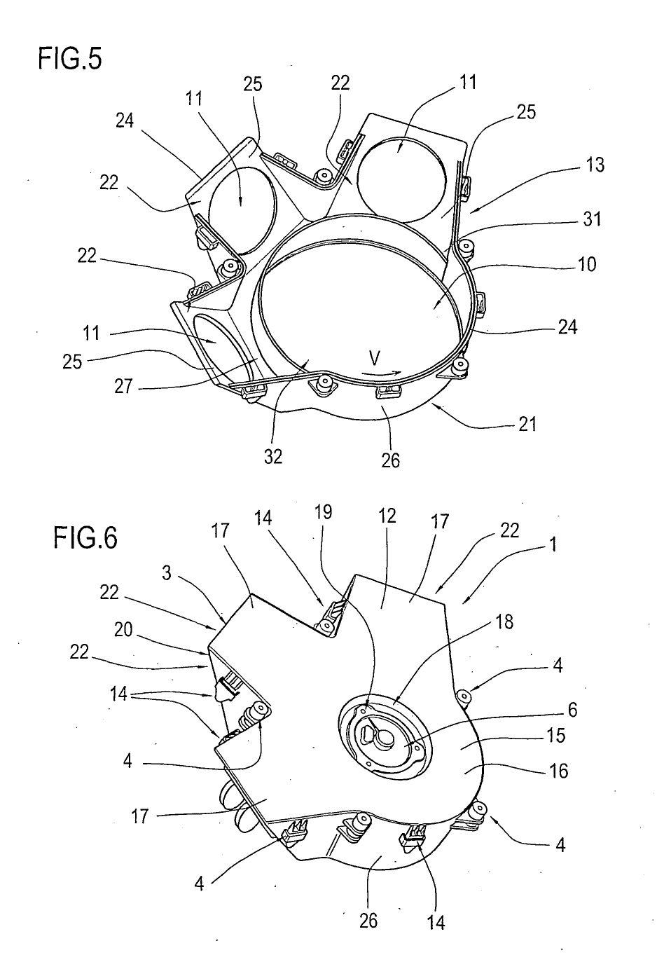

The housing is defined by two half-shells 12, 13 joined to each other in airtight manner and separable, the first half-shell 12, better illustrated in FIG. 6, being designed to be attached to the cabin roof, and the second half-shell 13, better illustrated in FIG. 5, having four circular openings defining the above mentioned air inlet and outlet openings 10, 11.

The airtight connection between the half-shells 12 and 13 is provided by customary seals, which are not illustrated, and by a plurality of press-in locking elements 14. The annular protrusions 4, defined by an annular portion of the half-shell 12 and an annular portion of the half-shell 13 also act, secondarily, as elements for locking the half-shells 12 and 13 to each other; in the embodiment shown in FIGS. 10 and 11, they are defined by annular portions of the half-shell 12 only. In any case, the protrusions 4 are positioned and adapted to attach the housing 3 directly to the cabin roof in a predetermined position such that the air inlet opening 10 lies in a substantially horizontal plane (FIG. 7a).

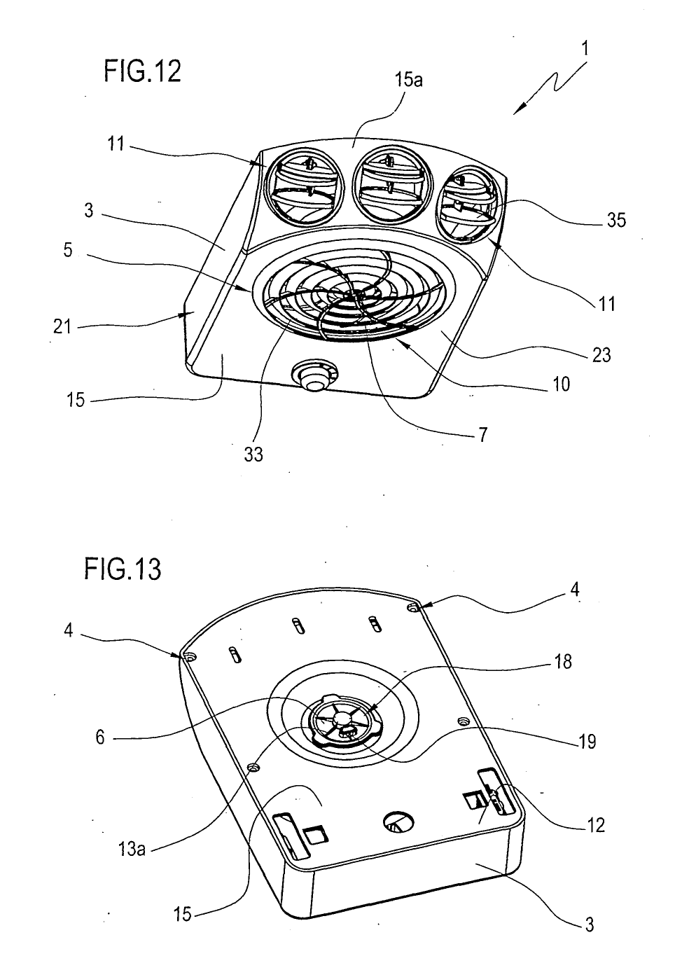

The half-shell 12 has, preferably, a flat bottom wall 15 defined by a circular portion 16 from which there extend, radially and in the same plane, three substantially trapezoidal extensions 17 whose minor bases face the opposite side of the portion 16. Alternatively, as shown in FIGS. 10 to 13, the flat bottom wall 15 is defined by a substantially rectangular portion 16 which comprises the annular protrusions 4. The portion 16 houses the outlet openings 11, as illustrated in FIG. 10. In the embodiment of FIG. 12, the outlet openings 11 are made in a side wall 15a of the half-shell 12; the side wall 15a is positioned at an angle to the portion 16 and connected to the latter.

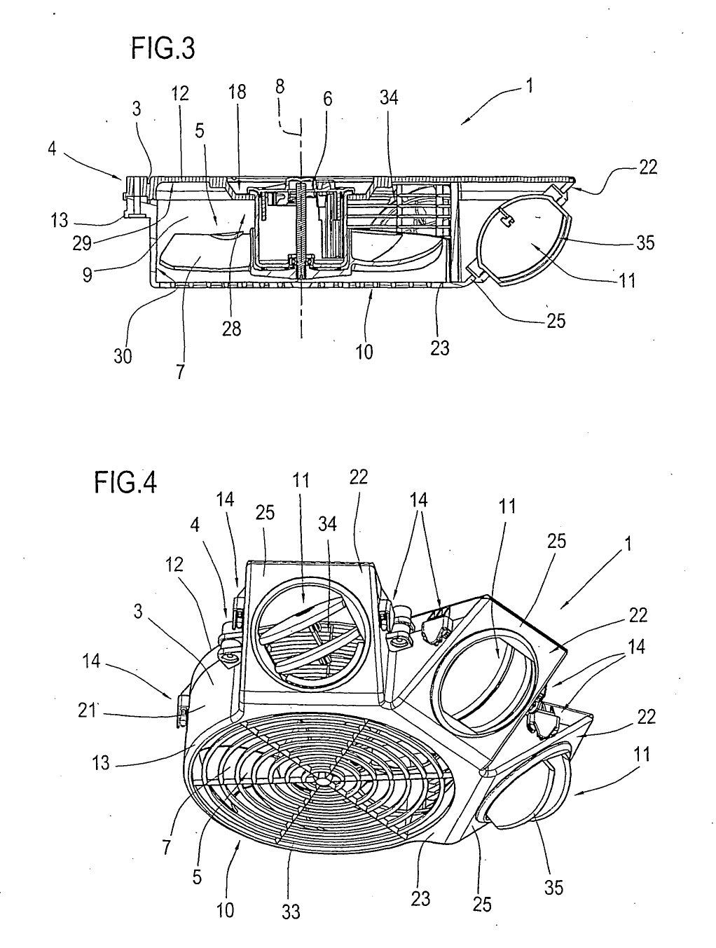

In the middle of the portion 16 there is a perforated seat 18 in which the motor 6 of the fan 5 is mounted (FIG. 3). Thus, as shown in FIGS. 6, 11 and 13, the power supply terminals 19 of the motor 6 can be accessed from the outside of the housing 3 so as to facilitate installation of the device 1.

When the motor 6 is attached to the portion 16 by screws or similar fastening means (not illustrated), the axis 8 of the impeller 7 is perpendicular to the portion 16 and centred with respect to the portion 16 itself.

The extensions 17 are spaced at equal angular intervals to describe a circular arc lying in the same plane as the wall 15, said arc subtending an angle at the centre of approximately 120°.

In a preferred embodiment, the three extensions 17 may be spaced at angular intervals of 60°.

In the preferred embodiment illustrated in FIG. 6, the half-shell 12 also has a protruding edge 20 extending around the periphery of the wall 15 except at the radial ends (minor bases) of the extensions 17.

The half-shell 13 is defined by a casing 21 which, in the preferred embodiment, is bell-shaped and substantially cylindrical, with a break on its side wall 26 from which there extend three prismatic extensions 22 with a substantially trapezoidal bases. Alternatively (see FIGS. 10 and 12) the casing 21 is prismatic in shape.

The casing 21 comprises a flat bottom wall 23 having a central through hole that constitutes the aforementioned air inlet opening 10.

Once the device 1 has been assembled, that is to say, when the two half-shells 12 and 13 are joined to each other, with the fan 5 positioned and fixed inside the housing 3, the wall 23 is positioned in such a way that it faces and is parallel to the wall 15, that is, at right angles to the axis of rotation 8 of the impeller 7. On closing the two parts of the device together, the extensions 22 of the preferred embodiment engage with the extensions 17 and the side wall 26 of the casing 21 is coupled with the circular portion 16 of the wall 15. More specifically, the half-shell 13 has, on the opposite side of the wall 23, a shaped edge 24 which, when the half-shells 12 and 13 are joined to each other, engages the edge 20 and the radial ends (minor bases) of the extensions 17 to provide an airtight seal.

The extensions 22 extend from the wall 23 with respective flat, substantially trapezoidal walls 25 which, inside the half-shell 13, all form the same predetermined obtuse angle with the plane in which the wall 23 lies and, in the middle of them, have respective through holes which define the aforementioned air outlet openings 11.

When the device 1 is assembled, in its preferred embodiment, the three air outlet openings 11 are arranged in a circle which lies in a plane at right angles to the axis of rotation 8 of the impeller 7 and whose centre coincides with the axis 8 itself.

Like the extensions 17 and 22, the air outlet openings 11 may be spaced at equal angular intervals to describe a circular arc corresponding to the transversal extension of the back seat of the vehicle (FIGS. 7a, 7b, 7c) in which the ventilating device according to the invention is installed.

In particular, each of the outlet openings 11 faces, and can be adjusted so its air jet is directed at, a passenger occupying the back seat of the vehicle.

In a preferred embodiment, the air outlet openings 11 are spaced at equal angular intervals to describe a circular arc subtending an angle at the centre of approximately 120°, that is to say, they are spaced at angular intervals of 60°.

In other embodiments that are not illustrated, the air outlet openings 11 may be spaced at equal angular intervals to describe a circular arc subtending an angle at the centre other than 120° but less than 180°, so that the outlet openings 11 always face the same side of a plane passing through the axis 8.

In the embodiment illustrated in FIG. 12, the air outlet openings 11 may be arranged on a single, uninterrupted arc-shaped extension, and not on several individual extensions.

In yet another embodiment that is not illustrated, there may be any number of outlet openings 11 (for example, five or six) arranged around the circumference of the ventilating device (or in a full circle of 360°). In this case, the outlet openings 11 face each of the passengers occupying both the front and back seats of the vehicle.

In all the embodiments illustrated, the half-shells 12 and 13, once joined to each other, define diverting means 27 surrounding the axial outlet of the impeller 7 so as to change the direction of the forced air flow from the impeller 7 by at least 90°.

The diverting means 27 comprise a substantially cylindrical cap 28 in which the impeller 7 is housed.

The cap 28 has a central axis coinciding with the axis of rotation 8 of the impeller 7, a bottom wall 29 defined by the aforementioned portion 16 of the wall 15 and facing the axial outlet of the impeller 7, and a side wall 30 defined by the wall 26, the edge 20 and a circular partition 31 inside the half-shell 13.

In another embodiment not illustrated, there is no edge 20 and the wall 30 is defined only by the half-shell 13.

The partition 31 faces the air outlet openings 11 in their entirety and extends from the wall 26, having the same radius and central axis as the wall 26, but being lower than the latter in the direction of the central axis coinciding with the axis 8, so that it is separated from the wall 15 of the half-shell 12 even in the absence of the edge 20. Thus, when the half-shells 12 and 13 are joined to each other, the partition 31 delimits an elongated opening 32 in the wall 30 facing the air outlet openings 11 as a whole.

In other words, the three air outlet openings 11 describe an arc around the partition 31 and the opening 32 between the two longitudinal ends of the partition 31 and of the opening 32 themselves.

In a direction parallel to the impeller 7 rotation axis 8, the opening 32 increases transversally in size between its aforementioned longitudinal ends in the rotation direction V of the impeller 7.

Correspondingly, in a direction parallel to the impeller 7 rotation axis 8, the partition 31 decreases transversally in size between its aforementioned longitudinal ends in the rotation direction V of the impeller 7.

In other words, from its highest point at the first outlet opening 11 the partition 31 becomes lower in the rotation direction V of the impeller 7 to reach its lowest point at the last outlet opening 11. Its height decreases gradually and the opening 32, viewed in cross section, is trapezoidal in shape so as to balance and uniformly circulate the air flowing out of the outlet openings 11.

Thus, the partition 31 acts as an equaliser and divider of the air flowing towards the outlet openings 11.

In another embodiment, the opening 32, viewed in cross section, is triangular in shape.

The device 1 comprises a circular safety grill 33 placed over the air inlet opening 10; in addition to the grill, there may also be another guard (not illustrated) to prevent small objects and other foreign matter, such as hair, from being sucked in by the fan.

The additional guard may comprise a layer of sponge or felt of the type used to protect the air inlet of a hairdryer.

The guard in the air inlet opening 10, if made of suitable material, may also have a sound deadening function to reduce the noise made by the impeller 7. To enhance the sound deadening function, the air outlet openings 11 may also be provided with soundproofing material. The soundproofing material used in the inlet and outlet openings 10 and 11 must offer low resistance to air flow.

The housing 3 of the device 1 may also be lined with soundproofing material. In this case, the material must have sound absorbing or sound insulating properties, whereas low resistance to air flow is not required.

Sound deadening materials that may be used include open-cell polyester or polyurethane foams. The outside surface may be corrugated to enhance sound absorption properties.

The device 1 also comprises an elongated safety grill 34 at the opening 32 and air outlet openings 11. More specifically, the grill 33 covers the inlet opening 10 in substantially the same plane, whilst the grill 34 is applied to and closes the opening 32 inside the half-shell 13.

Customary baffles 35 are fitted to the outlet openings 11 in substantially the same plane; these are designed not only to divert the air flow but also to reduce it or even shut it off completely, if necessary.

Instead of being attached directly to the cabin roof, the housing 3 may be fitted to the cabin on a prismatic mount 36, as illustrated in FIGS. 7b and 7c. The prismatic mount 36 can in turn be attached to the cabin roof by means of screws or similar fastening elements which are not illustrated.

In this case, the prismatic mount 36, the annular protrusions 4 and the fastening screws are positioned and adapted to attach the housing 3 directly to the cabin roof in a predetermined position such that the air inlet opening 10 lies in a plane that is inclined downwardly, from the front to the back of the vehicle cabin. This improves the circulation of the conditioned air from the front of the vehicle cabin (FIG. 7c).

In all its embodiments, as well as in the variants illustrated in FIGS. 7b and 7c, the device 1 can be equipped with an air conduit 37 in the form of a tubular extension connected to the air inlet opening 10 and having, in turn, an opening 38 positioned and oriented in such a way as to intercept the air flowing out of a vehicle 2 climate control system 39 in an open area of the vehicle cabin.

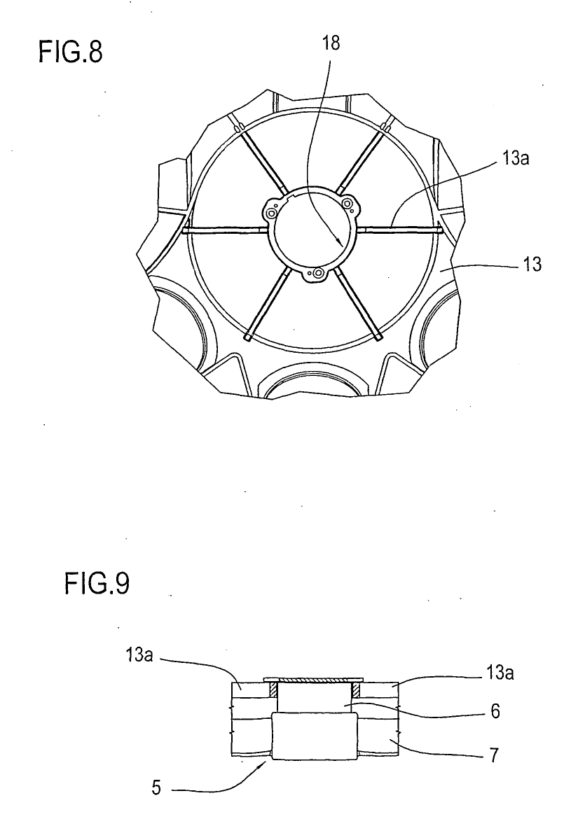

In the embodiment illustrated in FIGS. 8, 9, 11 and 13, the motor 6 of the impeller 7 is fixed to the second half-shell 13 by mounting elements 13a embodied by a spider that supports the seat 18 for the motor 6. In this case, too, the device 1 has a compact structure in the vertical direction since the spider is very low and, besides, does not create resistance to the air flow produced by the fan.

In another embodiment of it (not illustrated), the ventilating device, which may also be made as a retrofit accessory, comprises a self-contained climate control system including one or more heating or cooling means. These heating or cooling means, consisting for example of heat exchangers built into the ventilating device itself, can be used to produce a flow of warm or cool air or a mixture of the two.

In this case, the device according to the invention supplements and assists the main climate control system built into the motor vehicle by recirculating, warming or cooling the air delivered to the cabin by the main climate control system or it may operate fully independently to warm or cool the vehicle cabin even when the main climate control system is off.

The invention described can be modified and adapted in several ways without thereby departing from the scope of the inventive concept, as defined in the claims herein. LIST OF REFERENCE CHARACTERS

| | |
|---|---|
| 1 | Ventilating device |
| 2 | Automobile |
| 3 | Housing |
| 4 | Protrusions |
| 5 | Fan |
| 6 | Motor |
| 7 | Impeller |
| 8 | Axis of rotation |
| 9 | Chamber |
| 10 | Air inlet opening |
| 11 | Air outlet openings |
| 12 | First half-shell |
| 13 | Second half-shell |
| 13a | Mounting elements |
| 14 | Locking elements |
| 15 | Flat wall |
| 15a | Side wall |
| 16 | Circular portion |
| 17 | Extensions |
| 18 | Seat |
| 19 | Terminals |
| 20 | Edge |
| 21 | Casing |
| 22 | Extensions |
| 23 | Flat wall |
| 24 | Edge |
| 25 | Flat walls |
| 26 | Side wall |
| 27 | Diverting means |
| 28 | Cap |
| 29 | Bottom wall |
| 30 | Side wall |
| 31 | Partition |
| 32 | Elongated opening |
| 33 | Grill |
| 34 | Grill |
| 35 | Baffles |
| 36 | Prismatic mount |
| 37 | Conduit |
| 38 | Opening |
| 39 | Climate control system |
| V | Direction of rotation |

1. A motor vehicle ventilating device comprising a housing (3), fastening means (4) for attaching the housing (3) to the roof of the cabin of a motor vehicle (2) and a fan (5) positioned in the housing (3); the housing (3) defining a closed chamber (9) equipped with an air inlet opening (10) and at least one air outlet opening (11) for delivering to the vehicle cabin through the outlet opening (11) the air that is drawn into the housing (3) by the fan (5) through the inlet opening (10); the device (1) being characterised in that the housing (3) is defined by two half-shells (12, 13) joined to each other in airtight manner, the first half-shell (12) being designed to be attached to the cabin roof and the second half-shell (13) having the air inlet and outlet openings (10, 11) made in it; the fan (5) being an axial fan.

2. The device according to claim 1, characterised in that the air outlet opening (11) is positioned at the side of the impeller (7) in a radial direction of the impeller (7) itself.

3. The device according to claim 1, characterised in that the air outlet opening (11) is positioned at the side of the impeller (7) in a skew direction of the impeller (7) itself.

4. The device according to claim 1, characterised in that the air outlet opening (11) is positioned in the same plane as the impeller (7) in a direction parallel to but offset from the impeller (7) itself.

5. The device according to claim 1, characterised in that the first half-shell (12) has made in it a seat (18) for mounting the motor (6) of the fan (5) impeller (7).

6. The device according to claim 1, characterised in that the second half-shell (13) is equipped with mounting elements (13a) for supporting a seat (18) in which the motor (6) of the fan (5) impeller (7) can be mounted.

7. The device according to claim 1, characterised in that it comprises diverting means (27) surrounding the axial outlet of the impeller (7) to change the direction of the forced air flow from the impeller (7) by at least 90°.

8. The device according to claim 1, characterised in that the housing (3) has a plurality of air outlet openings (11).

9. The device according to claim 2, characterised in that the air outlet openings (11) are arranged in a circle which lies in a plane at right angles to the axis of rotation (8) of the impeller (7) and whose centre coincides with the axis (8) itself.

10. The device according to claim 9, characterised in that the air outlet openings (11) are uniformly distributed around a circular arc forming a part of said circle.

11. The device according to claim 10, characterised in that said circular arc corresponds to the transversal extension of the front and/or back seats of the vehicle (2) in which the ventilating device (1) is installed.

12. The device according to claim 10, characterised in that said circular arc subtends an angle of less than 180° at the centre.

13. The device according to claim 12, characterised in that said circular arc subtends an angle of 120° at the centre.

14. The device according to claim 13, characterised in that it comprises at least three outlet openings (11) spaced at angular intervals of 60°.

15. The device according to claim 7, characterised in that the diverting means (27) comprise a substantially cylindrical cap (28) in which the impeller (7) is housed, the cap (28) having a central axis that coincides with the central axis of rotation (8) of the impeller (7), a bottom wall (29) facing the axial outlet of the impeller (7) and a side wall (30) with an elongated opening (32) facing the air outlet openings (11) in their entirety; the air outlet openings (11) as a whole describing an arc around the opening (32) between two longitudinal ends of the opening (32) itself.

16. The device according to claim 15, characterised in that the bottom wall (29) of the cap (28) is defined by the first half-shell (12) and the side wall (30) of the cap (28) is defined entirely or mainly by the second half-shell (13).

17. The device according to claim 15, characterised in that the elongated opening (32), in a direction parallel to the impeller (7) rotation axis (8), increases transversally in size between its longitudinal ends in the rotation direction (V) of the impeller (7) itself.

18. The device according to claim 17, characterised in that the elongated opening (32) has a trapezoidal or triangular shape in cross section so as to balance and uniformly circulate the air flowing out of the outlet openings (11).

19. The device according to claim 1, characterised in that it comprises a safety grill (33) placed over the air inlet opening (10).

20. The device according to claim 1, characterised in that it comprises a safety grill (34) placed over the air outlet opening (11).

21. The device according to claim 1, characterised in that the air inlet opening (10) lies in a plane at right angles to the axis of rotation (8) of the impeller (7).

22. The device according to claim 2, characterised in that the air outlet opening (11) lies in a plane that makes a predetermined obtuse angle with the plane in which the air inlet opening (10) lies.

23. The device according to claim 22, characterised in that the fastening means (4) are positioned and designed to attach the housing (3) to the vehicle cabin roof in a predetermined position such that the air inlet opening (10) lies in a substantially horizontal plane.

24. The device according to claim 22, characterised in that the fastening means (4) are positioned and designed to attach the housing (3) to the vehicle cabin roof in a predetermined position such that the air inlet opening (10) lies in a plane that is inclined downwardly, from the front to the back of the vehicle cabin.

25. The device according to claim 1, characterised in that it comprises an air conduit (37) in the form of a tubular extension connected to the air inlet opening (10) and having, in turn, an opening (38) positioned and oriented in such a way as to intercept the air flowing out of a vehicle climate control system (39) in an open area of the vehicle cabin.

26. The device according to claim 1, characterised in that it comprises one or more heating or cooling means consisting, for example, of heat exchangers built into the ventilating device (1) and used to produce a flow of warm or cool air or a mixture of the two.

27. The device according to claim 1, characterised in that the air inlet opening (10) comprises a layer of protective material designed to prevent small objects and other foreign matter, such as hair, from being sucked into it.

28. The device according to claim 1, characterised in that the air inlet opening (10) comprises a layer of sound deadening material having low resistance to air flow.

29. The device according to claim 1, characterised in that the air outlet opening or openings (11) comprise a layer of sound deadening material having low resistance to air flow.

30. The device according to claim 1, characterised in that the housing (3) comprises a layer of sound-deadening material consisting, for example, of open-cell polyester or polyurethane foam.
